(19) United States
(12) Patent Application Publication
(10) Pub. No.: US 2025/0353473 A1
(43) Pub. Date: Nov. 20, 2025

(54) Tire Sidewall Cleaning Device

(71) Applicants: Juan Banuelos, Cerritos, CA (US); Andrew Zuniga, Cerritos, CA (US)

(72) Inventors: Juan Banuelos, Cerritos, CA (US); Andrew Zuniga, Cerritos, CA (US)

(21) Appl. No.: 18/665,783

(22) Filed: May 16, 2024

(51) Int. Cl. B60S 3/04

(52) U.S. Cl. CPC B60S 3/047

(57) ABSTRACT

A tire sidewall cleaning device includes a housing, a handle, and a sponge pad, wherein the housing has an inlet port for the pouring of liquid into the housing and the sponge pad. The housing and the sponge pad have an inner arcuate edge that is designed to essentially follow the circumferential radial curve of a wheel rim to permit application of tire shine along the entirety of a tire sidewall with minimal or no contact with the wheel rim.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to car cleaning devices and more particularly pertains to a new tire sidewall cleaning device for efficiently cleaning tire sidewalls. Cleaning or shining tire sidewalls usually involves spraying on the tire shine liquid and using cloths or towels to spread it evenly and wipe it off. Not only is this messy and inefficient, but it can lead to tire shine liquid being dripped onto the wheel rims.

### (2) Description of Related Art Including Information Disclosed Under 37 CFR 1.97 and 1.98

The prior art relates to car cleaning devices. The prior art, as best understood, does not disclose a tire sidewall cleaning device that includes a housing, a handle, and a sponge pad, wherein the housing has an inlet port for the pouring of liquid into the housing and the sponge pad. The housing and the sponge pad have an inner arcuate edge that is designed to essentially follow the circumferential radial curve of a wheel rim to permit application of tire shine along the entirety of a tire sidewall with minimal or no contact with the wheel rim.

### BRIEF SUMMARY OF THE INVENTION

An embodiment of the disclosure meets the needs presented above in a tire sidewall cleaning device generally comprising a housing, a handle, and a sponge pad. The housing has a rectangular shape. The housing includes a front face and a rear face. The handle is connected to and projecting from the rear face. The sponge pad has a similar rectangular shape as the housing and is mounted on the front face. The housing includes an inlet port that is positioned on and projecting from the rear face. The inlet port is designed to permit the pouring of tire shine liquid into the housing and the sponge pad to permit tire shine liquid to saturate the sponge pad and permit even application of tire shine to a tire sidewall. Each of the housing and the sponge pad have a similar length and width. The width is approximately the same size as the thickness of a tire sidewall such that the sponge pad contacts the entire thickness upon application of tire shine with the sponge pad. Each of the housing and the sponge pad have an inner arcuate edge and an outer arcuate edge along the length. The inner arcuate edge is designed to essentially follow the circumferential radial curve of a wheel rim to permit application of tire shine along the entirety of a tire sidewall with minimal or no contact with the wheel rim. The inner arcuate edge can function as a guide during the application process and promotes complete application of tire shine liquid to the entirety of the tire sidewall.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a tire sidewall cleaning device according to an embodiment of the disclosure.

FIG. 2 is a rear perspective view of an embodiment of the disclosure.

FIG. 3 is a rear view of an embodiment of the disclosure in use.

FIG. 4 is a front view of an embodiment of the disclosure.

FIG. 5 is a side cross-sectional view of an embodiment of the disclosure.

FIG. 6 is a view of an embodiment of the disclosure in use.

FIG. 7 is a side view of an embodiment of the disclosure.

### DETAILED DESCRIPTION OF THE INVENTION

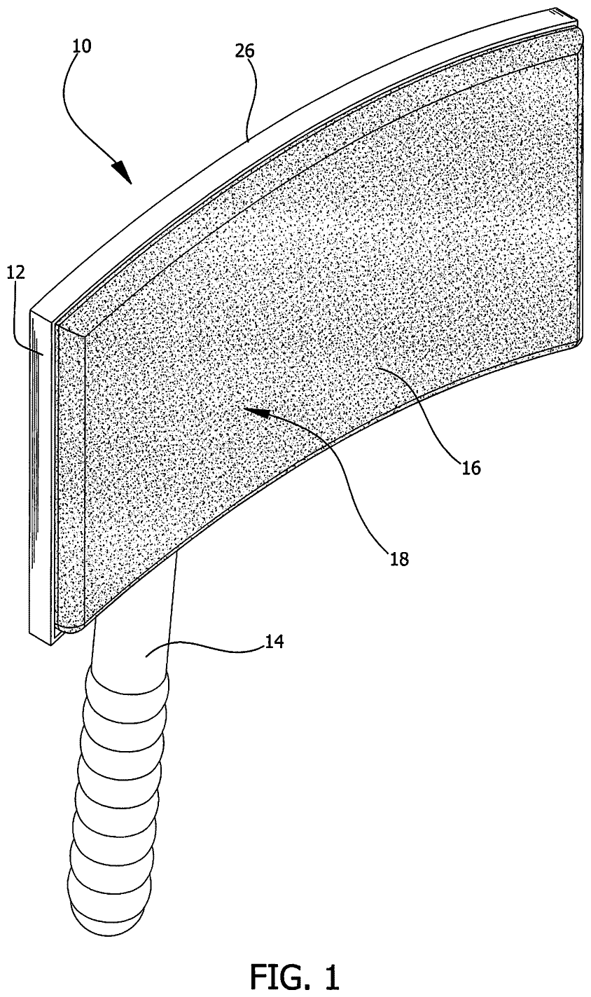

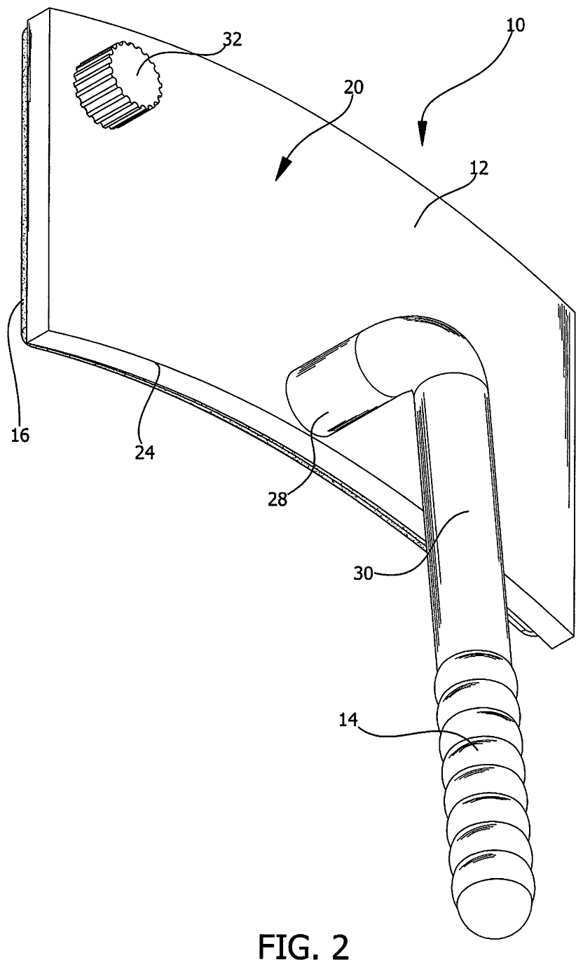

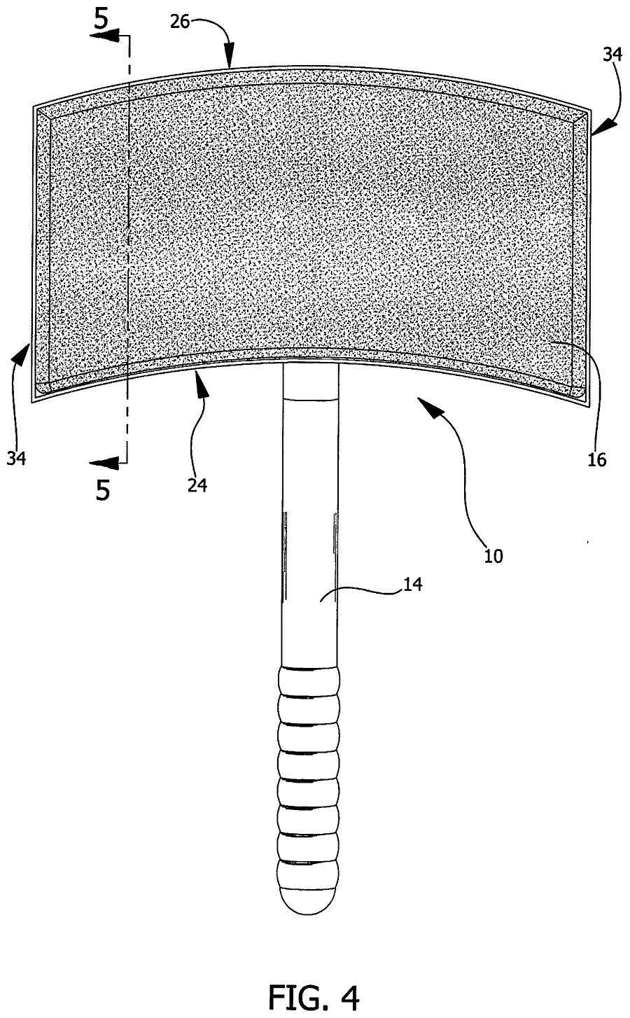

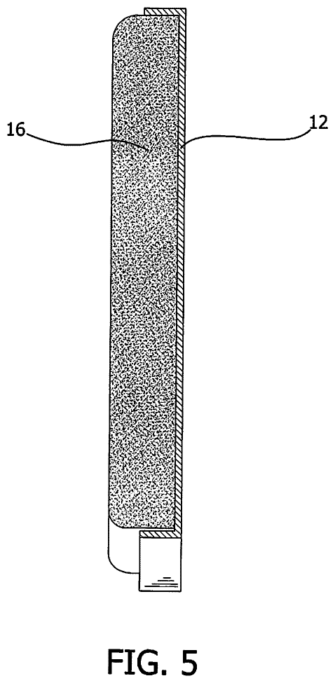

With reference now to the drawings, and in particular to FIGS. 1 through 7 thereof, a new tire sidewall cleaning device embodying the principles and concepts of an embodiment of the disclosure and generally designated by the reference numeral 10 will be described.

As best illustrated in FIGS. 1 through 7, the tire sidewall cleaning device 10 generally comprises a housing 12, a handle 14, and a sponge pad 16. The housing 12 has a rectangular shape. The housing 12 includes a front face 18 and a rear face 20. The handle 14 is connected to and projecting from the rear face 20. The sponge pad 16 has a similar rectangular shape as the housing 12 and is mounted on the front face 18. The housing 12 includes an inlet port 22 that is positioned on and projecting from the rear face 20. The inlet port 22 is designed to permit the pouring of tire shine liquid 60 into the housing 12 and the sponge pad 16 to permit tire shine liquid 60 to saturate the sponge pad 16 and permit even application of tire shine liquid 60 to a tire sidewall 62. Each of the housing 12 and the sponge pad 16 have a similar length and width. The width is approximately the same size as the thickness of a tire sidewall 62 such that the sponge pad 16 contacts the entire thickness upon application of tire shine with the sponge pad 16. Each of the housing 12 and the sponge pad 16 have an inner arcuate edge 24 and an outer arcuate edge 26 along the length. The inner arcuate edge 24 is designed to essentially follow the circumferential radial curve of a wheel rim to permit application of tire shine along the entirety of a tire sidewall 62 with minimal or no contact with the wheel rim 64. The inner arcuate edge 24 can function as a guide during the application process and promotes complete application of tire shine liquid 60 to the entirety of the tire sidewall 62.

In accordance with at least one possible embodiment, the handle 14 includes a first portion 28 extending perpendicularly out of a central portion of the rear face 20 and a second portion 30 designed and positioned to extend transverse and radially with respect to the first portion 28.

In accordance with at least one possible embodiment, the inlet port 22 includes a screw-on cap 32.

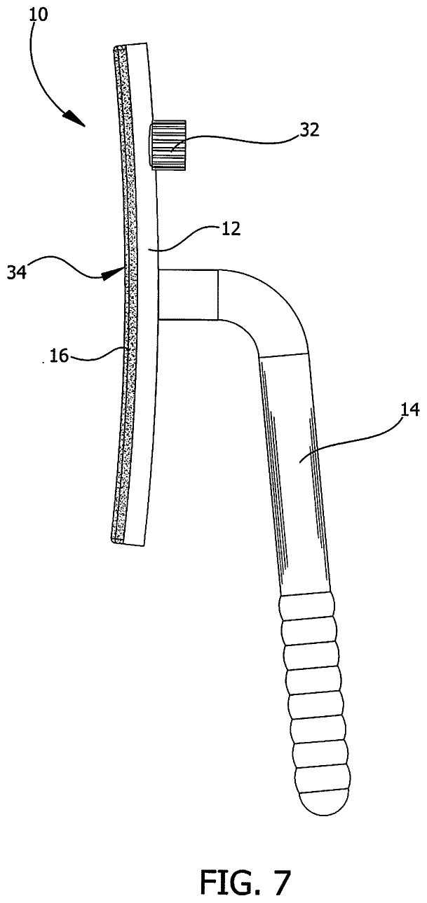

In accordance with at least one possible embodiment, each of the housing 12 and the sponge pad 16 includes two straight edges 34 along the width. Alternatively, in accordance with at least one possible embodiment, each of the housing 12 and the sponge pad 16 includes two curved edges 34 along the width, as shown in FIG. 7. This design gives the housing 12 and sponge pad 16 a slightly concave shape that follows a slightly convex tire sidewall 62.

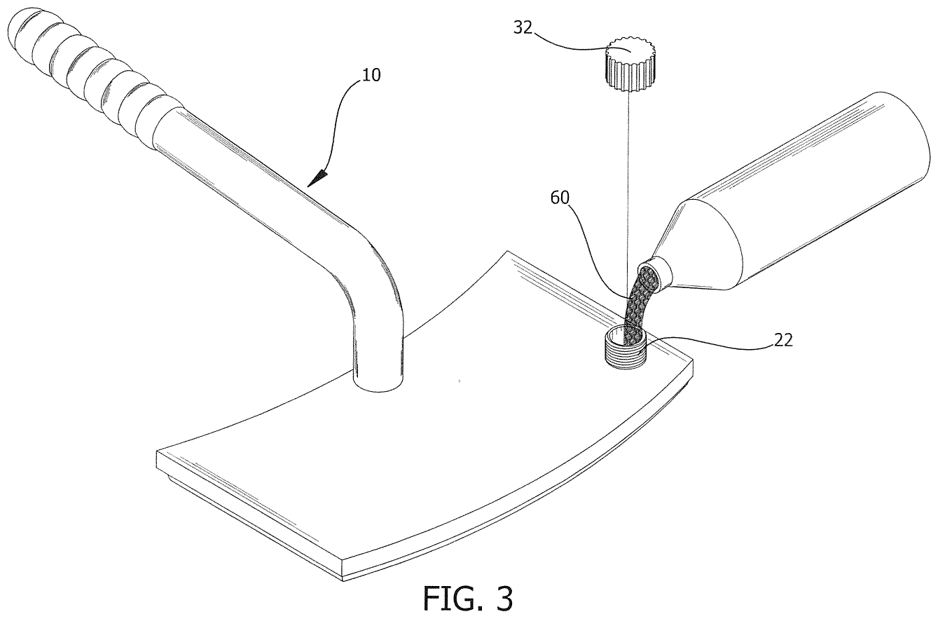

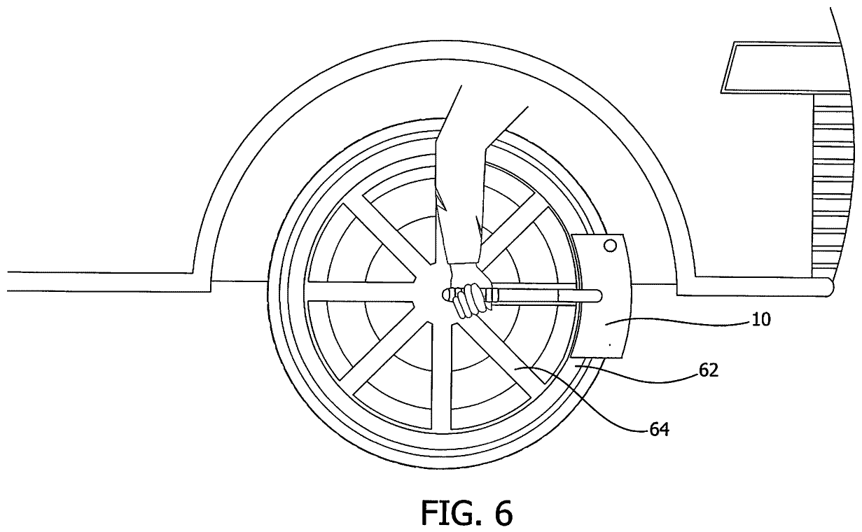

In order to shine a tire sidewall 62 using the tire sidewall cleaning device 10, the user first pours tire shine liquid 60 into the inlet port 22 and saturates at least a portion of the sponge pad 16, as seen in FIG. 3. The user then orients the sponge pad 16 toward a tire sidewall 62, as shown in FIG. 6. The user also aligns the inner arcuate edge 24 with a circumferential outer edge of a wheel rim 64. The user then presses the sponge pad 16 against the tire sidewall 62 and expresses tire shine liquid 60 out of the sponge and onto the tire sidewall 62. The user then moves the tire sponge 16 along a circular path on the tire sidewall 62 and about the wheel rim 64 to evenly apply tire shine liquid 60 to the tire sidewall 62 with minimal to no drippage of tire shine liquid 60 onto the wheel rim 64s or the ground.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A tire sidewall cleaning device comprising:
a housing having a rectangular shape;
said housing comprising a front face and a rear face;
a handle being connected to and projecting from said rear face;
a sponge pad having a similar rectangular shape as said housing and being mounted on said front face;
said housing comprising an inlet port being disposed on and projecting from said rear face;
said inlet port being configured to permit the pouring of tire shine liquid into said housing and said sponge pad to permit tire shine liquid to saturate said sponge pad and permit even application of tire shine to a tire sidewall;
each of said housing and said sponge pad having a similar length and width wherein said width is approximately the same size as the thickness of a tire sidewall such that said sponge pad contacts the entire thickness upon application of tire shine with said sponge pad;
each of said housing and said sponge pad having an inner arcuate edge and an outer arcuate edge along said length; and
said inner arcuate edge being configured to essentially follow the circumferential radial curve of a wheel rim to permit application of tire shine along the entirety of a tire sidewall with minimal or no contact with the wheel rim.

2. The tire sidewall cleaning device of claim 1, wherein said handle comprises a first portion extending perpendicularly out of a central portion of said rear face and a second portion configured and disposed to extend transverse and radially with respect to said first portion.

3. The tire sidewall cleaning device of claim 2, wherein said inlet port comprises a screw-on cap.

4. The tire sidewall cleaning device of claim 3, wherein each of said housing and said sponge pad comprises two straight edges along said width.

5. The tire sidewall cleaning device of claim 3, wherein each of said housing and said sponge pad comprises two curved edges along said width.

6. The tire sidewall cleaning device of claim 1, wherein said inlet port comprises a screw-on cap.

7. The tire sidewall cleaning device of claim 1, wherein each of said housing and said sponge pad comprises two straight edges along said width.

8. The tire sidewall cleaning device of claim 1, wherein each of said housing and said sponge pad comprises two curved edges along said width.

9. A method of shining a tire sidewall using the tire sidewall cleaning device of claim 1 comprising:
pouring tire shine liquid into said inlet port and saturating at least a portion of said sponge pad;
orienting said sponge pad toward a tire sidewall;
aligning said inner arcuate edge with a circumferential outer edge of a wheel rim;
pressing said sponge pad against said tire sidewall and expressing tire shine liquid out of said sponge and onto said tire sidewall; and
moving said tire sponge along a circular path on said tire sidewall and about said wheel rim to evenly apply tire shine liquid to said tire sidewall with minimal to no drippage of tire shine liquid onto said wheel rims or the ground.
